(19) United States
(12) Patent Application Publication
(10) Pub. No.: US 2004/0169892 A1
(43) Pub. Date: Sep. 2, 2004

(54) Device and method for generating a print, device and method for detecting information, and program for causing a computer to execute the information detecting method

(75) Inventor: Akira Yoda, Kanagawa-Ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/786,503

(22) Filed: Feb. 26, 2004

(30) Foreign Application Priority Data
Feb. 28, 2003 (JP) 053480/2003
Dec. 16, 2003 (JP) 417985/2003

(51) Int. Cl. G06K 15/02; G06T 5/00; G06T 7/00

(52) U.S. Cl. 358/3.28; 382/100; 382/275

(57) ABSTRACT

A print generating device for hiddenly embedding first information in an image to acquire an information-attached image and generating a print on which the information-attached image is recorded. The print generating device includes an information attaching unit for attaching second information, which indicates that the first information is embedded in the image, to the print.

### BACKGROUND OF THE INVENTION

1. Field of the Invention

The present invention relates to a device and method for attaching information to an image and generating a print on which an information-attached image is recorded, a device and method for detecting the information attached to an image, and a program for causing a computer to execute the information detecting method.

2. Description of the Related Art

Electronic information acquiring systems are in wide use. For example, like a uniform resource locator (URL), information representing the location of electronic information is attached to image data as a bar code or digital watermark. The image data with the information is printed out and a print with an information-attached image is obtained. This print is read by a reader such as a scanner and the read image data is analyzed to detect the information attached to the image data. The electronic information is acquired by accessing its location. Such systems are disclosed in patent document 1 (U.S. Pat. No. 5,841,978), patent document 2 (Japanese Unexamined Patent Publication No. 2000-232573), non-patent document 1 {Digimarc MediaBridge Home Page, Connect to what you want from the web (URL in the Internet: http://www.digimarc.com/mediabridge/)}, etc.

There are also disclosed methods of embedding two digital watermarks in an image, in patent document 3 (Japanese Unexamined Patent Publication No. 2000-287067), non-patent document 2 {Content ID Forum (URL in the Internet: http://www.cidf.org/english/specification.html)}, etc. In patent document 3, first information to specify a system is embedded using a watermark embedding method common to a plurality of systems, and second information is embedded using another watermark embedding method unique to each system. In a certain system, the first information is extracted from an image by a common watermark extracting method in order to specify a system in which that watermark is embedded, and the image is transferred to the specified system. In non-patent document 2, information representing a previously registered watermark form is embedded in an image by a standard watermark embedding method, and according to the previously registered watermark form, a variety of information are embedded in the image.

On the other hand, with the rapid spread of cellular telephones, portable terminals with built-in cameras, such as cellular telephones with a digital camera capable of acquiring image data by photography, have recently spread {e.g., patent document 4 (Japanese Unexamined Patent Publication No. 6(1994)-233020, patent document 5 (Japanese Unexamined Patent Publication No. 2000-253290), etc.}. Also, there have been proposed portable terminals having cameras incorporated therein, such as personal digital assistants (PDA's) {patent document 6 (Japanese Unexamined Patent Publication No. 8 (1996)-140072), patent document 7 (Japanese Unexamined Patent Publication No. 9(1997)-65268), etc.}

By employing the above-described portable terminal with a built-in camera, favorite image data acquired by photography can be set as wallpaper in the liquid crystal monitor of the portable terminal. The acquired image data can also be transmitted to friends along with electronic mail. When you must call off your promise or are likely to be late for your appointment, the present situation can be transmitted to friends. For example, you can photograph your face, featuring an apologetic look, and transmit it to friends. Thus, portable terminals with a built-in camera are convenient for achieving better communication between friends.

Also, if a print with electronic information embedded in the above-described way is photographed by a portable terminal with a built-in camera, and information on the location of the electronic information is detected, the electronic information can be acquired by accessing that location from the portable terminal.

However, because a digital watermark is used for hiddenly embedding predetermined information in an image, a glance at a print with a watermark-embedded image cannot enable judgment regarding whether or not a watermark is embedded in the image recorded on the print. For that reason, in the systems disclosed in the above-described patent documents 1, 2 and non-patent document 1, it is necessary to detect a watermark from a print to find the presence of the watermark, but when no watermark is embedded in the print, the detection process will be wasted. Particularly, when a device for performing that detection process is installed in a server that receives image data obtained by photographing prints transmitted from many terminals, the server receives image data that does not need to be processed and is therefore congested. This congestion will retard the process of detecting a watermark from photographed image data obtained from a print containing an embedded watermark.

If the process for detecting a watermark is performed, a service charge for that process is incurred and the user requesting the watermark detection process has to bear the service charge. However, since the detection process is performed even when no watermark is embedded, the service charge is incurred, and consequently, the user must pay a wasteful charge.

### SUMMARY OF THE INVENTION

The present invention has been made in view of the above-described circumstances. Accordingly, it is the object of the present invention to perform a watermark detection process on only an image with an embedded watermark.

To achieve this end, there is provided a print generating device for hiddenly embedding first information in an image to acquire an information-attached image and generating a print on which the information-attached image is recorded. The print generating device comprises information attaching means for attaching second information, which indicates that the first information is embedded in the image, to the print.

The aforementioned second information can employ any information if it can be recognized that the aforementioned first information is hiddenly embedded in an image. For example, in addition to a visual mark, such as a symbol, text, etc., which indicates that the first information is embedded in an image, the second information can employ a hiddenly embedded digital watermark, etc.

In the print generating device of the present invention, the aforementioned information attaching means may be means to attach the second information to the print by hiddenly embedding the second information in the image in a different embedding manner than the manner in which the first information is embedded.

The different embedding manner is intended to mean a manner which is easier to process than the manner in which the first information is embedded, and by which the embedded second information can be detected more easily. For example, since the second information is used for indicating that the first information is embedded in an image, it can employ an embedding manner that is less in information amount than the manner in which the first information is embedded, or an embedding manner that is narrow in bandwidth. By adopting such an embedding manner, it becomes easy to detect the second information.

The aforementioned information attaching means may be means to attach the second information to the print by a visual mark.

In accordance with the present invention, there is provided a first information detecting device comprising (1) input means for receiving photographed-image data obtained by photographing an arbitrary print, which includes the print generated by the aforementioned print generating device, with image pick-up means; (2) judgment means for judging whether or not second information, which indicates that first information is embedded in an image, is detected from the photographed-image data; and (3) processing means for performing a process for detection of the first information on only the photographed-image data from which the second information is detected.

The aforementioned image pick-up means can employ a wide variety of means such as a digital camera, scanner, etc., if they are able to acquire image data representing an image recorded on a print.

The aforementioned process for detection of the first information can employ various processes if they can detect the first information as a result. More specifically, the process includes not only detection of the first information but also a device for detecting the first information and a process of transmitting photographed-image data to a server in which that device is installed, etc.

The first information detecting device of the present invention may further comprise distortion correction means for correcting geometrical distortions contained in the photographed-image data when the aforementioned processing means is a means for performing detection of the first information as a process for detection of the first information. The aforementioned judgment means and processing means may be a means for performing the judgment and the detection on the photographed-image data corrected by the distortion correction means.

In this case, the aforementioned distortion correction means may be a means for correcting geometrical distortions caused by a photographing lens provided in the image pick-up means and/or geometrical distortions caused by a tilt of an optical axis of the photographing lens relative to the print.

In the first information detecting device of the present invention, the aforementioned processing means may be a means for performing a process of transmitting the photographed-image data to a device that detects the first information, as a process for detection of the first information. The processing means may also be a means for transmitting the photographed-image data to the device that detects the first information, only when the judgment means detects the second information from the photographed-image data.

In accordance with the present invention, there is provided a second information detecting device comprising (1) input means for receiving photographed-image data obtained by photographing an arbitrary print, which includes the print generated by the print generating device of the present invention, with image pick-up means, and (2) processing means for performing a process for detection of the first information.

The second information detecting device of the present invention may further comprise distortion correction means for correcting geometrical distortions contained in the photographed-image data when the processing means is means to perform detection of the first information as a process for detection of the first information. The aforementioned processing means may be means to perform the process for detection on the photographed-image data corrected by the distortion correction means.

In the second information detecting device of the present invention, the aforementioned distortion correction means may be means to correct geometrical distortions caused by a photographing lens provided in the image pick-up means and/or geometrical distortions caused by a tilt of an optical axis of the photographing lens relative to the print.

In the first and second information detecting devices of the present invention, the aforementioned image pick-up means may be a camera provided in a portable terminal.

In the first and second information detecting devices of the present invention, the aforementioned image pick-up means may be equipped with display means for displaying the print to be photographed, tilt detection means for detecting a tilt of an optical axis of the image pick-up means relative to the print, and display control means for displaying information representing the tilt of the optical axis detected by the tilt detection means, on the display means.

In the first and second information detecting devices of the present invention, the aforementioned first information may be location information representing a storage location of audio data correlated with the image. The first and second information detecting devices of the present invention may further comprise audio data acquisition means for acquiring the audio data, based on the location information.

In accordance with the present invention, there is provided a print generating method comprising the steps of embedding first information in an image hiddenly and acquiring an information-attached image; generating a print on which the information-attached image is recorded; and attaching second information, which indicates that the first information is embedded in the image, to the print.

In the print generating method of the present invention, the second information may be attached to the print by hiddenly embedding the second information in the image in a different embedding manner from the manner in which the first information is embedded.

In accordance with the present invention, there is provided an information detecting method comprising the steps of receiving photographed-image data obtained by photographing an arbitrary print, which includes the print generated by the print generating method, with image pick-up means; judging whether or not second information, which indicates that first information is embedded in an image, is detected from the photographed-image data; and performing a process for detection of the first information on only the photographed-image data from which the second information is detected.

Note that the print generating method and information detecting method of the present invention may be provided as programs for causing a computer to execute the methods.

According to the print generating device and method of the present invention, the second information, which indicates that the first information is embedded in an image, is attached to a print. For this reason, based on the presence of the second information in a print, it can be easily judged whether or not the first information is hiddenly embedded in an image recorded on the print.

Particularly, if the second information is attached to a print by being hiddenly embedded in an image, like a digital watermark, the second information, which indicates that the first information is embedded in an image recorded on a print, can be attached to the image so it is not deciphered. In this case, the second information can be hiddenly embedded. Also, by hiddenly embedding the second information in an image in a different embedding manner than the manner in which the first information is embedded, the second information can be detected more easily than the first information.

If the second information is attached to a print by a visual mark, a glance at the print can enable recognition regarding whether or not the first information is embedded in an image.

According to the first information detecting device and method of the present invention, photographed-image data representing an information-attached image recorded on a print is obtained by photographing an arbitrary print, which includes the print generated by the print generating device and method of the present invention, with image pick-up means. Next, it is judged whether or not the second information is detected from the photographed-image data, and a process for detection of the first information is performed on only the photographed-image data from which the second information is detected. The second information is embedded in an image in a different embedding manner from the manner in which the first information is embedded, so detection of the second information is easier than that of the first information. Therefore, it can be easily judged whether or not the second information is embedded in an image, and a process for detection of the second information can be performed on only a print in which the second information is embedded.

The process for detection of the first information is performed only on a print on which an image with the first information is recorded, so a device that performs that process does not have to perform the process for detection of the first information on a print on which an image having no first information is recorded. Thus, the load on the device that performs the process can be reduced. Even when a service charge for the detection process is incurred, a user requesting that process will not have to pay a wasteful charge, because that process is performed on only a print from which the first information is detected.

In the first information detecting device and method of the present invention, geometrical distortions in the photographed-image data are corrected and the first information and second information are detected from the corrected image data. Therefore, even when photographed-image data contains geometrical distortions, the first information and second information can be accurately detected in a distortion-free state.

In the case where geometrical distortions in an image obtained by an inexpensive photographing lens are great, as in the case of a camera provided in a portable terminal, or the case where it is difficult to make the optical axis of the image pick-up means perpendicular to a print, the effect of correction of the present invention is extremely great.

According to the second information detecting device and method of the present invention, photographed-image data representing an information-attached image recorded on a print is obtained by photographing an arbitrary print, which includes the print with visual second information generated by the print generating device and method of the present invention, with image pick-up means. Next, a process for detection of the first information is performed on the photographed-image data. The second information is attached to a print so it can be visually recognized. Therefore, a device that performs the process does not have to perform the process for detection of the first information on a print on which an image having no first information is recorded. Thus, the load on the device that performs the process can be reduced. Even when a service charge for detection of the first information is incurred, a user requesting the detection process will not have to pay a wasteful charge, because that process is performed on only a print from which the first information is detected.

In the second information detecting device and method of the present invention, geometrical distortions in the photographed-image data are corrected and the first information is detected from the corrected image data. Therefore, even when photographed-image data contains geometrical distortions, the first information can be accurately detected in a distortion-free state.

In the second information detecting device and method of the present invention, the effect of correction of the present invention is extremely great when geometrical distortions in an image obtained by an inexpensive photographing lens are great, as in the case of a camera provided in a portable terminal, or when it is difficult to make the optical axis of the image pick-up means perpendicular to a print.

By displaying the tilt of the optical axis on the display means of a camera, a print can be photographed so the optical axis is substantially perpendicular to the print. Thus, detection accuracy for the first information can be enhanced.

In the case where the first information is location information representing a storage location such as the URL of audio data correlated with an image, the audio data can be acquired by accessing the URL of the audio data, based on the location information. Thus, users are able to reproduce audio data correlated with an image.

### BRIEF DESCRIPTION OF THE DRAWINGS

The present invention will be described in further detail with reference to the accompanying drawings wherein:

FIG. 1 is a block diagram showing an information attaching system with a print generating device constructed in accordance with an embodiment of the present invention;

FIG. 2 is a diagram for explaining extraction of face regions;

FIG. 3 is a diagram for explaining how blocks are set;

FIG. 4 is a diagram for explaining a watermark embedding algorithm;

FIG. 5 is a flowchart showing the steps performed in attaching information;

FIG. 6 is a simplified block diagram showing an information transmission system constructed in accordance with a first embodiment of the present invention;

FIGS. 7A and 7B are diagrams for explaining the tilt of an optical axis;

FIG. 8A is a diagram showing the shape of a print when the optical axis is tilted;

FIG. 8B is a diagram showing the shape of the print when the optical axis is not tilted;

FIG. 9 is a flowchart showing the steps performed in the first embodiment;

FIG. 10 is a simplified block diagram showing an information transmission system constructed in accordance with a second embodiment of the present invention;

FIG. 11 is a flowchart showing the steps performed in the second embodiment;

FIG. 12 is a simplified block diagram showing a cellular telephone relay system that is an information transmission system constructed in accordance with a third embodiment of the present invention;

FIG. 13 is a flowchart showing the steps performed in the third embodiment;

FIG. 14 is a diagram showing the state in which a symbol is printed;

FIG. 15 is a simplified block diagram showing an information transmission system constructed in accordance with a fourth embodiment of the present invention;

FIG. 16A is a diagram showing the shape of a mark ⊚ when an optical axis is tilted;

FIG. 16B is a diagram showing the shape of the mark ⊚ when the optical axis is not tilted;

FIG. 17 is a simplified block diagram showing another embodiment of the cellular telephone with a built-in camera; and

FIGS. 18A and 18B are diagrams for explaining how information representing the tilt of the optical axis is displayed.

### DESCRIPTION OF THE PREFERRED EMBODIMENTS

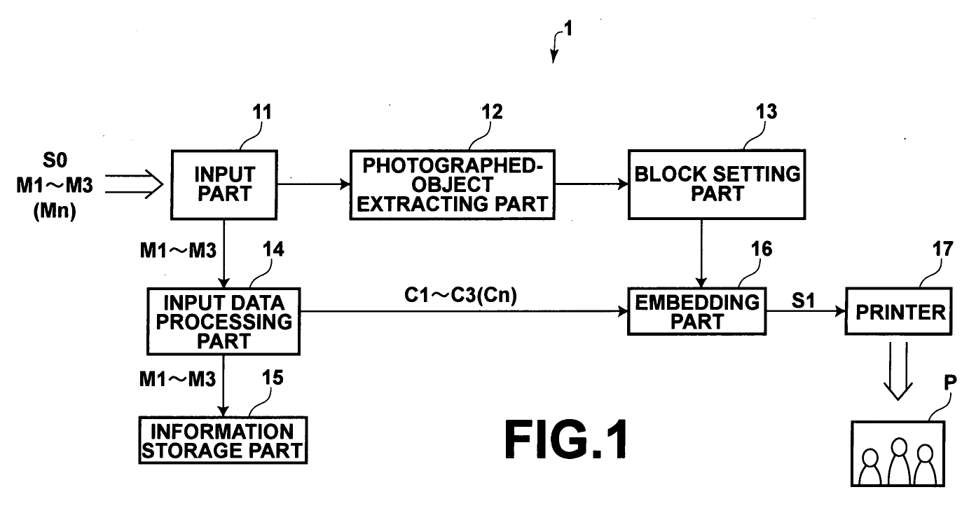

Referring to FIG. 1, there is shown an information attaching system with a print generating device constructed in accordance with an embodiment of the present invention. As shown in the figure, the information attaching system 1 is installed in a photo studio where image data S0 is printed. For that reason, the information attaching system 1 is equipped with an input part 11, a photographed-object extracting part 12, and a block setting part 13. The input part 11 receives image data S0 and audio data Mn correlated to the image data S0. The photographed-object extracting part 12 extracts photographed objects from an image represented by the image data S0. The block setting part 13 partitions the image into blocks, each of which contains a photographed object. The information attaching system 1 is further equipped with an input data processing part 14, an information storage part 15, an embedding part 16, and a printer 17. The input data processing part 14 generates code Cn (first information) representing a location where the audio data Mn is stored. The information storage part 15 stores a variety of information such as audio data Mn, etc. The embedding part 16 embeds the code Cn in the image data S0, also embeds second information W indicating that the code Cn (first information) is embedded in the image data S0, and acquires information-attached image data S1 having the embedded code Cn and second information W. The printer 17 prints out the information-attached image data S1.

In this embodiment, an image represented by the image data S0 is assumed to be an original image, which is also represented by S0. The original image S0 contains three persons, so the audio data Mn (where n=1 to 3) consists of audio data M1 to M3, which represent the voices of the three persons, respectively.

The audio data M1 to M3 are recorded by a user who acquired the image data S0 (hereinafter referred to as an acquisition user). The audio data M1 to M3 are recorded, for example, when the image data S0 is photographed by a digital camera, and are stored in a memory card along with the image data S0. If the acquisition user takes the memory card to a photo studio, the audio data M1 to M3 are stored in the information storage part 15 of the photo studio. The acquisition user may also transmit the audio data M1 to M3 to the information attaching system 1 via the Internet, using his or her personal computer.

There are cases where one frame of a motion picture photographed by a digital video camera is printed out. In this case, the audio data M1 to M3 can employ audio data recorded along with the motion picture.

The input part 11 can employ a variety of means capable of receiving the image data S0 and audio data M1 to M3, such as a medium drive to read out the image data S0 and audio data M1 to M3 from various media (CD-R, DVD-R, a memory card, and other storage media) recording the image data S0 and audio data M1 to M3, a communication interface to receive the image data S0 and audio data M1 to M3 transmitted via a network, etc.

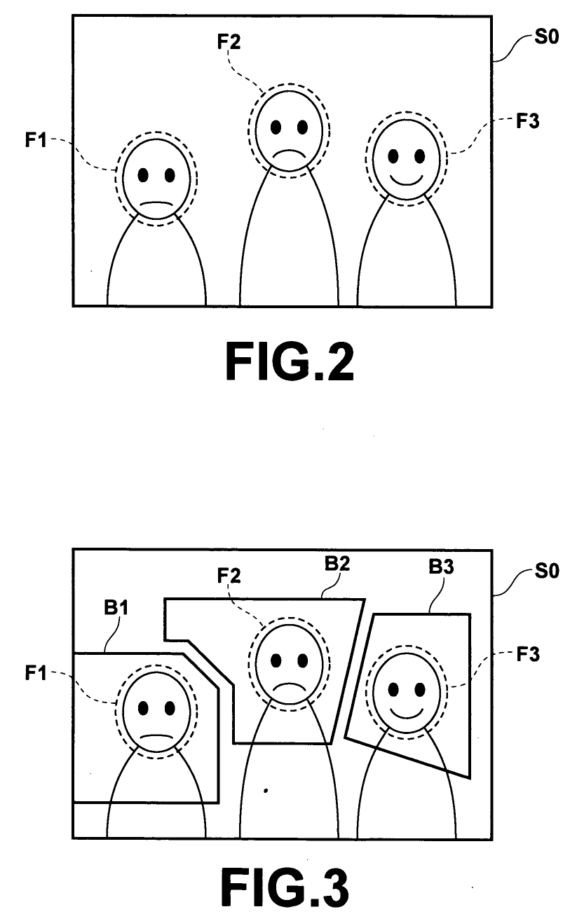

The photographed-object extracting part 12 extracts face regions F1 to F3 containing a human face from the original image S0 by extracting skin-colored regions or face contours from the original image S0, as shown in FIG. 2.

The block setting part 13 sets blocks B1 to B3 for embedding codes C1 to C3 to the original image S0 so that the blocks B1 to B3 contain the face regions F1 to F3 extracted by the photographed-object extracting part 12 and so that the face regions F1 to F3 do not overlap each other. In this embodiment, the blocks B1 to B3 are set as shown in FIG. 3.

This embodiment extracts face regions from the original image S0, but the present invention may detect specific photographed objects such as seas, mountains, flowers, etc, and set blocks containing these objects to the original image S0.

Also, by partitioning the original image S0 into a plurality of blocks on the basis of a characteristic quantity such as luminance (monochrome brightness), color difference, etc., the blocks may be set in the original image S0 without extracting specific photographed objects such as faces, etc.

The input data processing part 14 stores the audio data M1 to M3 received by the input part 11 in the information storage part 15, and also generates codes C1 to C3, which correspond to the audio data M1 to M3. Each of the codes C1 to C3 is a uniform resource locator (URL) consisting of 128 bits and representing the storage location of each of the audio data M1 to M3.

The information storage part 15 is installed in a server, which is accessed from personal computers (PCs), cellular telephones, etc., as described later.

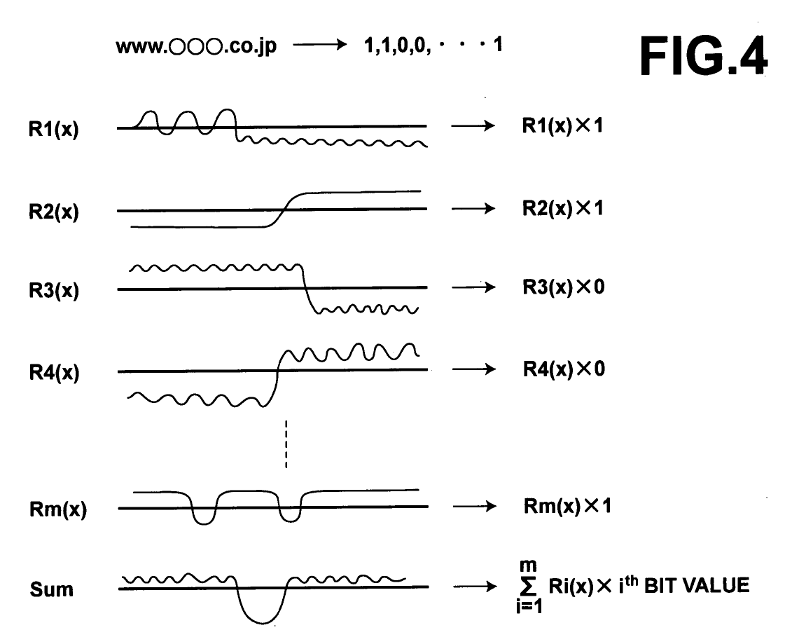

The embedding part 16 embeds codes C1 to C3 in the blocks B1 to B3 of the original image S0 as digital watermarks. FIG. 4 is a diagram for explaining a watermark embedding algorithm that is performed by the embedding part 16. First, m kinds of pseudo random patterns Ri(x, y) (in this embodiment, 128 kinds because codes C1 to C3 are 128 bits) are generated. The random patterns Ri are actually two-dimensional patterns Ri(x, y), but for explanation, the random patterns Ri(x, y) are represented as one-dimensional patterns Ri(x). Next, the i^{th} random pattern Ri(x) is multiplied by the value of the i^{th} bit in the 128-bit information representing the URL of each of the audio data M1 to M3. For example, when the URL of audio data M1 is represented by code C1 (1, 1, 0, 0, . . . 1), R1(x)×1, R2(x)×1, R3(x)×0, R4(x)×0, . . . , Ri(x)×(value of the i^{th} bit), . . . , and Rm(x)×1 are computed and the sum of R1(x)×1, R2(x)×1, R3(x)×0, R4(x)×0, . . . , and Rm(x)×1 (=ΣRi(x)×i^{th} bit value) is computed. Then, the sum is added to the image data S0 within the block B1 in the original image S0, whereby the code C1 is embedded in the image data S0.

Similarly, for code C2, the sum of the products of the code C2 and random pattern Ri(x) is added to the image data S0 within the block B2, whereby the code C2 is embedded in the image data S0. For code C3, the sum of the products of the code C3 and random pattern Ri(x) is added to the image data S0 within the block B3, whereby the code C3 is embedded in the image data S0.

The embedding part 16 also embeds the second information W, which indicates that codes C1 to C3 are embedded in the image data S0, in the image data S0. The second information W is represented by only one bit because it is used for representing whether or not the codes C1 to C3 are embedded in the image data S0. More specifically, a two-dimensional pattern W(x, y) representing the second information W is added to the image data S0, whereby the second information W is embedded in the image data S0. Since the amount of the second information W is small like 1 bit, the pattern W(x, y) can be made a spatially low frequency pattern.

As set forth above, the image data with the embedded codes C1 to C3 and second information W is obtained as information-attached image data S1.

In the printer 17, the information-attached image data S1 with the embedded codes C1 to C3 and second information W is printed out as a print P.

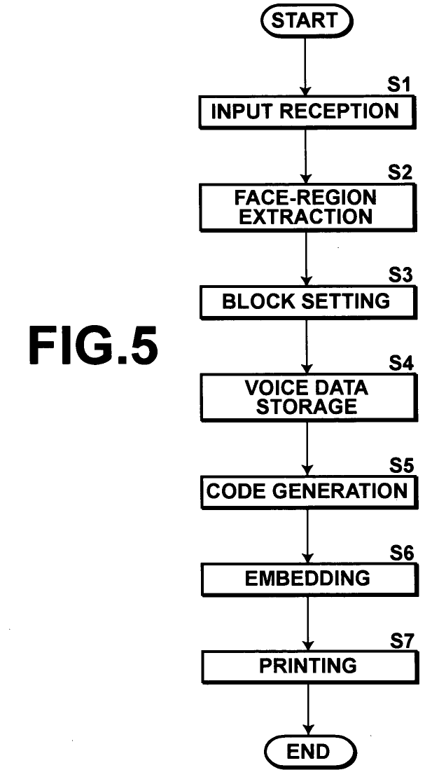

Next, a description will be given of the steps performed in attaching information. FIG. 5 is a flowchart showing the steps performed in attaching information. First, the input part 11 receives image data S0 and audio data M1 to M3 (step S1). The photographed-object extracting part 12 extracts face regions F1 to F3 from the original image S0 (step S2), and the block setting part 13 sets blocks B1 toB3 containing face regions F1 to F3 in the original image S0 (step S3).

Meanwhile, the input data processing part 14 stores the audio data M1 to M3 in the information storage part 15 (step S4), and further generates codes C1 to C3 (step S5), which represent the URLs of the audio data M1 to M3. Step S4 and step S5 may be performed in reversed order, but it is preferable to perform them in parallel. Also, steps S2 and S3 and steps S4 and S5 may be performed in reversed order, but it is preferable to perform them in parallel.

Subsequently, the embedding part 16 embeds the codes C1 to C3 in the blocks B1 to B3 of the original image S0, also embeds the second information W in the original image S0, and generates information-attached image data S1 that represents an information-attached image data having the embedded codes C1 to C3 and second information W (step S6). The printer 17 prints out the information-attached image data S1 as a print P (step S7), and the processing program ends.

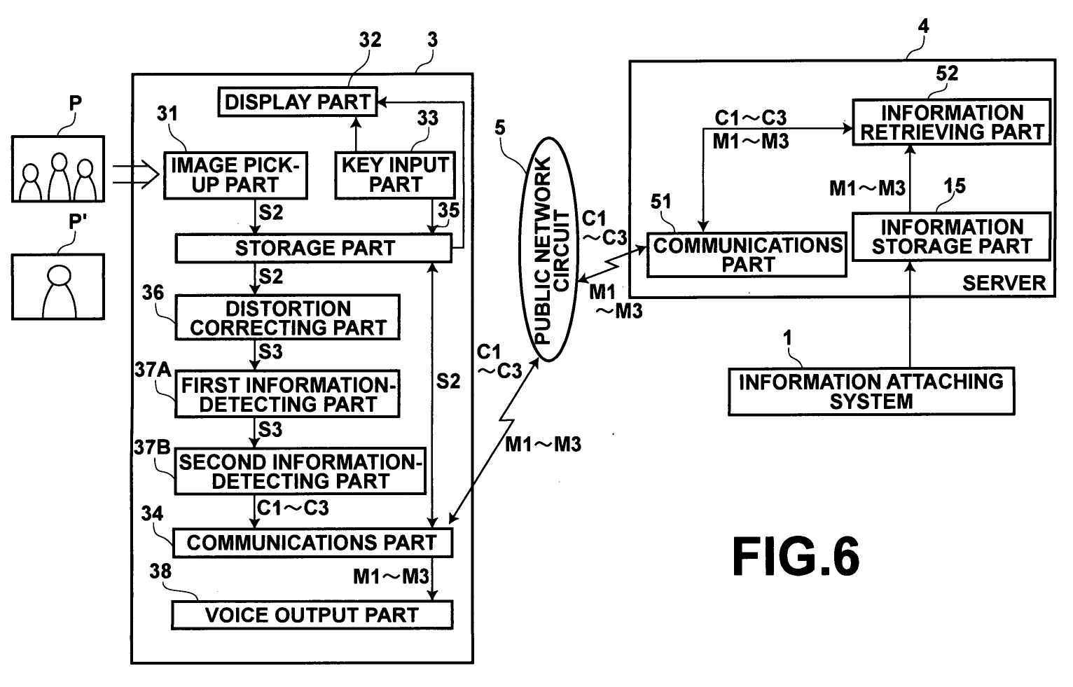

Next, a description will be given of an information transmission system equipped with a first information detecting device of the present invention. FIG. 6 shows the information transmission system with the first information detecting device, constructed in accordance with a first embodiment of the present invention. As shown in the figure, the information transmission system of the first embodiment is installed in a photo studio along with the above-described information attaching system 1. Data is transmitted and received through a public network circuit 5 between a cellular telephone 3 with a built-in camera (hereinafter referred to simply as a cellular telephone 3) and a server 4 with the information storage part 15 of the above-described information attaching system 1.

The cellular telephone 3 is equipped with an image pick-up part 31, a display part 32, a key input part 33, a communications part 34, a storage part 35, a distortion correcting part 36, a first information-detecting part 37A, a second information-detecting part 37B, and a voice output part 38. The image pick-up part 31 photographs the print P obtained by the above-described information attaching system 1 or print P′ described later, and acquires photographed-image data S2a representing an image recorded on the print P or P′. The display part 32 displays an image and a variety of information. The key input part 33 comprises many input keys such as a cruciform key, etc. The communications part 34 performs the transmission and reception of telephone calls, e-mail, and data through the public network circuit 5. The storage part 35 stores the photographed-image data S2 acquired by the image pick-up part 31, in a memory card, etc. The distortion correcting part 36 corrects distortions of the photographed-image data S2 and obtains corrected-image data S3. The first information-detecting part 37A judges whether or not codes C1 to C3 are embedded in the print photographed, based on whether the second information W is embedded in the corrected-image data S3. The second information-detecting part 37B acquires the codes C1 to C3 embedded in the print from the corrected-image data S3 only when the first information-detecting part 37A detects the second information W. The voice output part 38 comprises a loudspeaker, etc.

The image pick-up part 31 comprises a photographing lens, a shutter, an image pick-up device, etc. For example, the photographing lens may employ a wide-angle lens with f≦28 mm in 35-mm camera conversion, and the image pick-up device may employ a color CMOS (Complementary Metal Oxide Semiconductor) device or color CCD (Charged-Coupled Device).

The display part 32 comprises a liquid crystal monitor unit, etc. In this embodiment, the photographed-image data S2 is reduced so the entire image can be displayed on the display part 32, but the photographed-image data S2 may be displayed on the display part 32 without being reduced. In this case, the entire image can be grasped by scrolling the displayed image with the cruciform key of the key input part 33.

Note that prints that are photographed by the image pick-up part 31 not only include the print P in which codes C1 to C3 representing the URLs of the audio data M1 to M3 corresponding to photographed objects contained in the print P are embedded as digital watermarks by the above-described information attaching system 1, but also include the print P′ in which any information is not embedded.

When the print P is photographed by the image pick-up part 31, the acquired photographed-image data S2 should correspond to the information-attached image data S1 acquired by the information attaching system 1. However, since the image pick-up part 31 uses a wide-angle lens as the photographing lens, the image represented by the photographed-image data S2 contains geometrical distortions caused by the photographing lens of the image pick-up part 31. Therefore, even if a value of correlation between the photographed-image data S2 and the pseudo random pattern Ri(x, y) or pattern W(x, y) is computed to detect the codes C1 to C3 and second information W, it does not become great because the embedded pseudo random pattern Ri(x, y) or pattern W(x, y) has distorted, and consequently, the codes C1 to C3 embedded in the print P cannot be detected.

For that reason, in this embodiment, the distortion correcting part 36 corrects geometrical distortions contained in the image represented by the photographed-image data S2 and acquires corrected-image data S3.

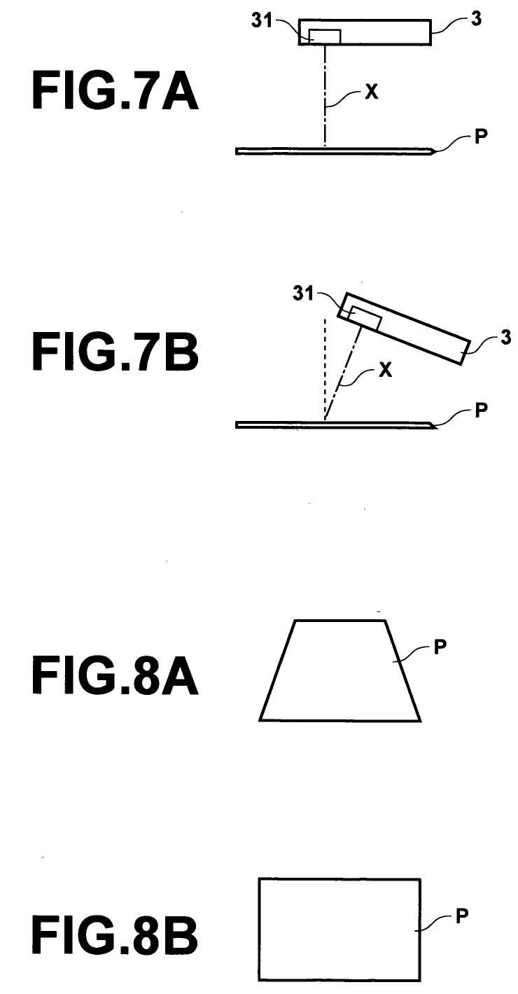

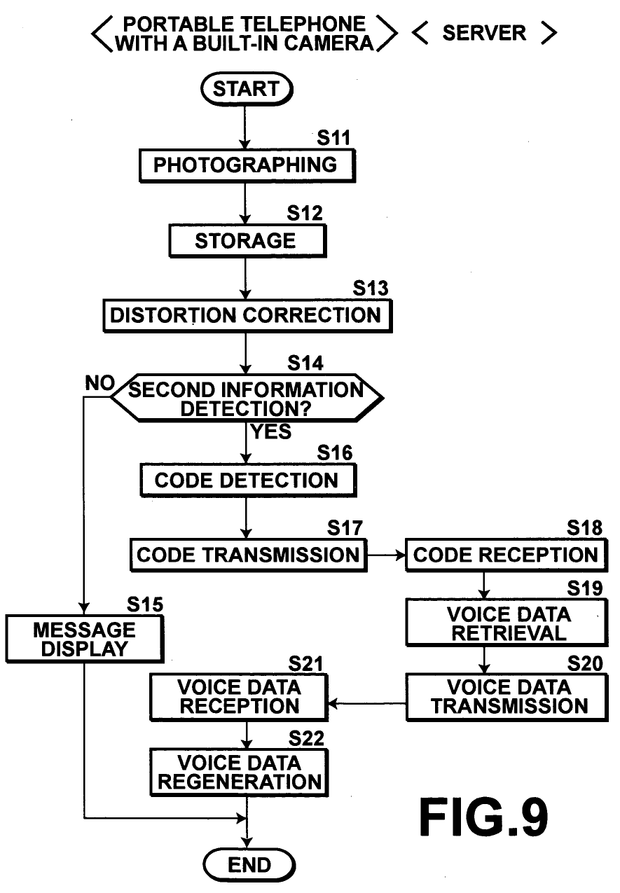

When photographing the print P, it is preferable that the optical axis X of the image pick-up part 31 of the cellular telephone 3 be perpendicular to the print P, as shown in FIG. 7A. However, in many cases, the optical axis X tilts as shown in FIG. 7B. If the optical axis X tilts, the image represented by the photographed-image data S2 will contain geometrical distortions caused by that tilt and therefore the codes C1 to C3 embedded in the print P cannot be detected. For that reason, the distortion correcting part 36 also corrects geometrical distortions caused by the tilt of the optical axis X and acquires corrected-image data S3.

If the print P is photographed with the optical axis X tilted, the angle between two sides of the print P crossing at right angles becomes greater or less than 90 degrees as shown in FIG. 8A, and the print P that should be rectangular in shape becomes a trapezoid. For that reason, the distortion correcting part 36 corrects the photographed-image data S2, in which the geometrical distortions caused by the photographing lens has been corrected, so that the trapezoidal print P becomes a rectangle, and acquires corrected-image data S3.

The first information-detecting part 37A computes a value of correlation between the corrected-image data S3 and the pattern W(x, y). If the correlation value is a predetermined threshold value or greater, the second information W is embedded in a photographed print, and consequently, it is judged that codes C1 to C3 are embedded in the print. On the other hand, if the correlation value is less than the threshold value, it is judged that codes C1 to C3 are not embedded in the photographed print, and a message indicating that effect, such as “Codes are not embedded in the print,” is displayed on the display part 32.

Note that the pattern W(x, y) is less susceptible to photographing-lens distortions because it is low-frequency information. For that reason, a value of correlation between the photographed-image data S2 and pattern W(x, y) is computed and it is judged whether or not the codes C1 to C3 are embedded in the photographed print, and only when it is judged that they are embedded in the print, the distortion correcting part 36 may correct the photographed-image data S2.

When the first information-detecting part 37A judges that the codes C1 to C3 are embedded in the photographed print, the second information-detecting part 37B computes a value of correlation between the corrected-image data S3 and pseudo random pattern Ri(x, y) and acquires the codes C1 to C3 representing the URLs of the audio data M1 to M3 embedded in the photographed print.

More specifically, correlation values between the corrected-image data S3 and all pseudo random patterns Ri(x, y) are computed. A pseudo random pattern Ri(x, y) with a relatively great correlation value is assigned a 1, and a pseudo random pattern Ri(x, y) other than that is assigned a 0. The assigned values 1s and 0s are arranged in order from the first pseudo random pattern R1(x, y). In this way, 128-bit information, that is, the URLs of the audio data M1 to M3 can be detected.

The server 4 is equipped with a communications part 51, an information storage part 15, and an information retrieving part 52. The communications part 51 performs data transmission and reception through the public network circuit 5. The information storage part 15 is included in the above-described information attaching system 1 and stores a variety of information such as audio data M1 to M3, etc. Based on the codes C1 to C3 transmitted from the cellular telephone 3, the information retrieving part 52 retrieves the information storage part 15 and acquires the audio data M1 to M3 specified by the URLs represented by the codes C1 to C3.

Next, a description will be given of the steps performed in the information transmission system constructed in accordance with the first embodiment. FIG. 7 is a flowchart showing the steps performed in the first embodiment. A print P or P′ is delivered to the user of the cellular telephone 3 (hereinafter referred to as the receiving user). In response to instructions from the receiving user, the image pick-up part 31 photographs the print P or P′ and acquires photographed-image data S2 representing the image of the print P or P′ (step S111) The storage part 35 stores the photographed-image data S2 temporarily (step S12). Next, the distortion correcting part 36 reads out the photographed-image data S2 from the storage part 35, also corrects the geometrical distortions in the photographed-image data S2 caused by the photographing lens and the geometrical distortions in the photographed-image data S2 caused by the tilt of the optical axis X, and acquires corrected-image data S3 (step S13).

The first information-detecting part 37A judges whether or not the second information W is detected from the corrected-image data S3 (step S14). If the judgment in step S14 is “NO,” the display part 32 displays a message such as “Codes are not embedded in the print” (step S15), and the processing program ends.

On the other hand, if the judgment in step S14 is “YES,” the second information-detecting part 37B detects codes C1 to C3 representing the URLs of the audio data M1 to M3 embedded in the corrected-image data S3 (step S16). If the codes C1 to C3 are detected, the communications part 34 transmits them to the server 4 through the public network circuit 5 (step S17).

In the server 4, the communications part 51 receives the transmitted codes C1 to C3 (step S18). The information retrieving part 52 retrieves audio data M1 to M3 from the information storage part 15, based on the URLs represented by the codes C1 to C3 (step S19). The communications part 51 transmits the retrieved audio data M1 to M3 through the public network circuit 5 to the cellular telephone 3 (step S20).

In the cellular telephone 3, the communications part 34 receives the transmitted audio data M1 to M3 (step S21), and the voice output part 38 regenerates the audio data M1 to M3 (step S22) and the processing program ends.

Since the transmittedaudiodataM1 toM3 are the voices of the three persons contained in the print P, the receiving user can hear the human voices, along with the image displayed on the display part 32 of the cellular telephone 3.

Thus, in this embodiment, the codes C1 to C3, representing the URLs of the audio data M1 to M3 of the photographed objects contained in the original image S0, are embedded and the second information W, indicating that the codes C1 to C3 are embedded in the print, is embedded. The information-attached image data S1 with the embedded codes C1 to C3 and second information W is printed out. The thus-obtained print P, or print P′ not containing any information, is photographed by the image pick-up part 31 of the cellular telephone 3 and the photographed-image data S2 is corrected. Next, it is judged whether or not the second information W is embedded in the corrected-image data S3. And only in the case where the second information W is embedded in the corrected-image data S3, the codes C1 to C3 are acquired from the corrected-image data S3.

The second information W is information that only represents whether or not codes C1 to C3 are embedded in the print P, so the information can be easily attached and detected. For that reason, detection of the second information W can be performed with fewer calculations than that of the codes C1 to C3. Thus, the cellular telephone 3 is able to judge whether or not the codes C1 to C3 are embedded in the print P or P′, in steps whose load is small. In addition, the procedure of detecting the codes C1 to C3 is performed only when the second information W is detected. Thus, for the photographed-image data S2 obtained by photographing the print P′ that does not have codes C1 to C3, the procedure of detecting codes C1 to C3, which requires many calculations, becomes unnecessary. This renders it possible to reduce the load of the procedures performed by the cellular telephone 3.

The geometrical distortions caused by the photographing lens of the image pick-up part 31 and the geometrical distortions caused by the tilt of the optical axis X are corrected. Therefore, even if the image pick-up part 31 does not have high performance and the photographed-image data S2 contains the geometrical distortions caused by the photographing lens of the image pick-up part 31, the codes C1 to C3 and second information W are embedded in the corrected image represented by the corrected-image data S3, without distortions. Also, even if the optical axis X of the image pick-up part 31 is not perpendicular to the print P, the codes C1 to C3 and second information W are embedded in the corrected image represented by the corrected-image data S3, without distortions. Thus, the embedded codes C1 to C3 and second information W can be detected with a high degree of accuracy.

In addition, in the above-described first embodiment, the print P contains three persons, so the face region of each person may be extracted from the image represented by the photographed-image data S2 so that the receiving user can select the face of each person. More specifically, by displaying each of the face regions in order on the display part 3 or displaying them side by side or numbering and selecting them, the receiving user may select the face image of each person. After the face image is selected, a code is detected from the face image selected by the receiving user. The detected code is transmitted to the server 4, by which only the audio data corresponding to that code is retrieved from the information storage 15. The audio data is transmitted to the cellular telephone 3.

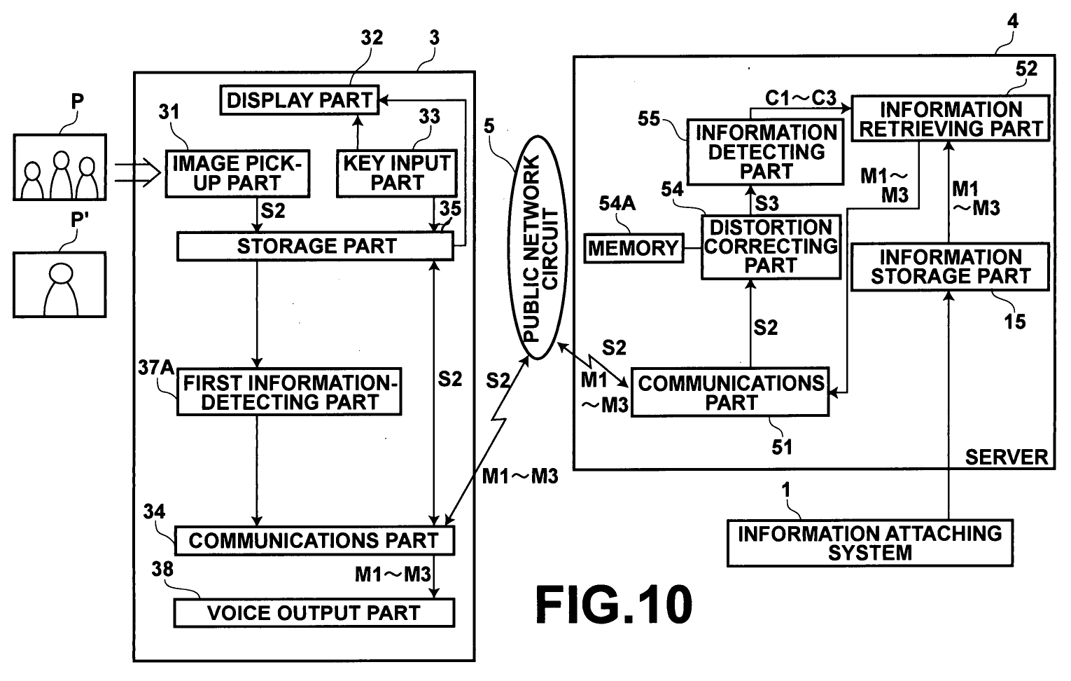

Next, a description will be given of a second information detecting device of the present invention. FIG. 10 shows an information transmission system equipped with the second information detecting device, constructed in accordance with a second embodiment of the present invention. In the second embodiment, the same reference numerals will be applied to the same parts as the first embodiment. Therefore, a detailed description will be omitted unless particularly necessary. The second embodiment differs from the first embodiment in that only when the second information W can be detected from photographed-image data S2 acquired by a cellular telephone 3, the photographed-image data S2 is transmitted to a server 4, by which codes C1 to C3 are detected. For that reason, in the second embodiment, the cellular telephone 3 has only a first information-detecting part 37A, while the server 4 is equipped with a distortion correcting part 54 and an information detecting part 55, which correspond to the distortion correcting part 36 and second information-detecting part 37B of the first embodiment.

In the second embodiment, the distortion correcting part 54 is equipped with memory 54A, which stores distortion characteristic information corresponding to the type of cellular telephone 3. In this memory 54A, the type information and distortion characteristic information on the cellular telephone 3 are stored so they correspond to each other. Based on model type information transmitted from the cellular telephone 3, distortion characteristic information corresponding to that model type is read out from the memory 54A. The geometrical distortions in photographed-image data S2 caused by the photographing lens is corrected based on the distortion characteristic information read out. Note that the cellular telephone 3 has an identification number peculiar to its model type. For that reason, in the case where the memory 54A stores information correlating a telephone number with the model type information, distortion characteristic information can be read out if the identification number of the cellular telephone 3 is transmitted.

Since the pattern W(x, y) for the second information W is low-frequency information, it is less vulnerable to distortions caused by the photographing lens and distortions caused by the tilt of the optical axis X. For that reason, by computing a correlation value between the photographed-image data S2 and the code-information pattern W(x, y), it can be judged whether or not codes C1 to C3 are embedded in a photographed print. Note that the cellular telephone 3 may be provided with a distortion correcting part. In this case, after the geometrical distortions in the photographed-image data S2 caused by the photographing lens and the geometrical distortions in the photographed-image data S2 caused by the tilt of the optical axis X are corrected, the first information-detecting part 37A detects the second information W. In this case, the correcting part 54 in the server 4 becomes unnecessary.

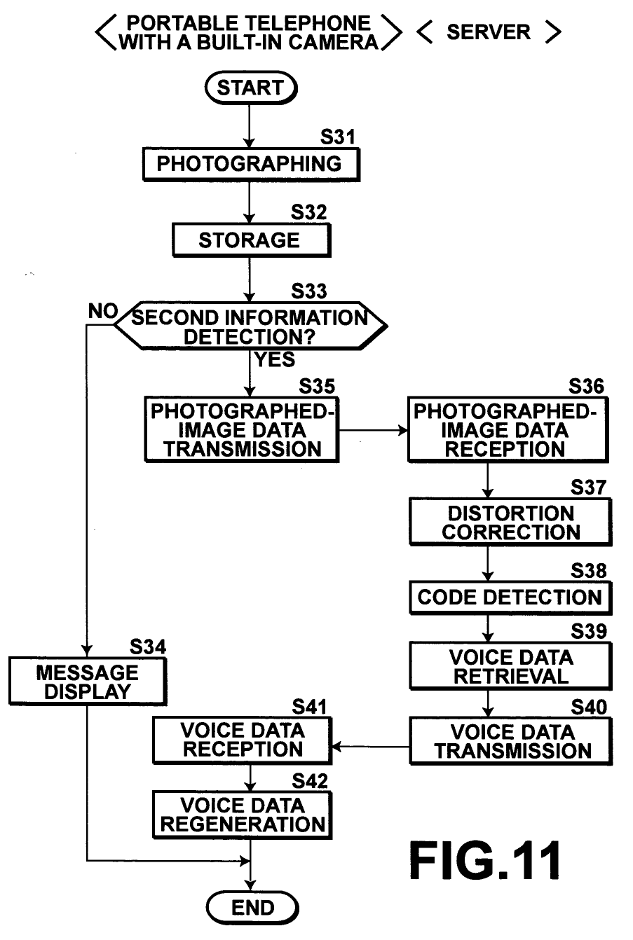

Next, a description will be given of the steps performed in the second embodiment of the present invention. FIG. 11 is a flowchart showing the steps performed in the second embodiment. A print P or P′ is delivered to the receiving user. In response to instructions from the receiving user, the image pick-up part 31 photographs the print P or P′ and acquires photographed-image data S2 representing the image of the print P or P′ (step S31). The storage part 35 stores the photographed-image data S2 temporarily (step S32).

Then, the first information-detecting part 37A judges whether or not the second information W is detected from the photographed-image data S2 (step S33). If the judgment in step S33 is “NO,” the display part 32 displays a message such as “Codes arenotembeddedinaprint” (stepS34), and the processing program ends.

On the other hand, if the judgment in step S34 is “YES,” the communications part 34 reads out the photographed-image data S2 from the storage part 35 and transmits it to the server 4 through a public network circuit 5 (step S35).

In the server 4, the communications part 51 receives the photographed-image data S2 (step S36). The distortion correcting part 54 corrects both the geometrical distortions in the photographed-image data S2 caused by the photographing lens and the geometrical distortions in the photographed-image data S2 caused by the tilt of the optical axis X and acquires corrected-image data S3 (step S37). Next, the information detecting part 55 detects codes C1 to C3 representing the URLs of audio data M1 to M3 embedded in the corrected-image data S3 (step S38). If the codes C1 to C3 are detected, the information retrieving part 52 retrieves the audio data M1 to M3 from the information storage part 15, based on the URLs represented by the codes C1 to C3 (step S39). The communications part 51 transmits the retrieved audio data M1 to M3 to the cellular telephone 3 through the public network circuit 5 (step S40).

In the cellular telephone 3, the communications part 34 receives the transmitted audio data M1 to M3 (step S41), and the voice output part 38 regenerates the audio data M1 to M3 (step S42) and the processing program ends.

Thus, in the second embodiment, the photographed-image data S2 is transmitted to the server 4 only in the case where codes C1 to C3 are embedded in the photographed print. Thus, the server 4 doesn't need to perform the distortion-correcting step and information-detecting step on photographed-image data S2 not containing codes C1 to C3. This can prevent server congestion. Also, the receiving user need not transmit unnecessary photographed-image data S2, so the receiving user is able to save the cost of communications and the cost in the server 4 for detecting codes C1 to C3.

In the second embodiment, the server 4 detects codes C1 to C3, so the cellular telephone 3 does not have to perform the step of detecting codes C1 to C3. Consequently, the processing load on the cellular telephone 3 can be reduced compared with the first embodiment. Because there is no need to install the distortion correcting part and second information-detecting part in the cellular telephone 3, the cost of the cellular telephone 3 can be reduced compared to the first embodiment, and the power consumption of the cellular telephone 3 can be reduced.

The algorithm for embedding codes C1 to C3 is updated daily, but the information detecting part 55 provided in the server 4 can deal with frequent updates of the algorithm.

In addition, in the above-described second embodiment, the print P contains three persons, so the face region of each person may be extracted from the image represented by the photographed-image data S2, and instead of the photographed-image data S2 the face image data representing the face of each person may be transmitted to the server 4. More specifically, by displaying each of the face regions in order on the display part 3 or displaying them side by side or numbering and selecting them, the face of each person can be selected. After the selection, image data corresponding to the selected face is extracted from the photographed-image data S2 as the face image data. The extracted face image data is transmitted to the server 4, in which only the audio data corresponding to the selected person is retrieved from the information storage 15. The audio data is transmitted to the cellular telephone 3.

Thus, the amount of data to be transmitted from the cellular telephone 3 to the server 4 can be reduced compared with the case of transmitting the photographed-image data S2. In addition, the calculation time in the server 4 for detecting embedded codes can be shortened. This makes it possible to transmit audio data to receiving users quickly.

In the above-described second embodiment, the distortion correcting part 54 corrects the geometrical distortions caused by the tilt of the optical axis X. However, by photographing the print P a plurality of times while changing the angle of the optical axis X relative to the print P little by little, and computing in the first information-detecting part 37A the correlation values between all the photographed-image data S2 obtained by photographing the print P a plurality of times and the pattern W(x, y), only the photographed-image data S2 with the highest correlation value may be transmitted from the communications part 34 to the server 4. In this case, the distortion correcting part 54 in the server 4 need not correct the geometrical distortions in the photographed-image data S2 caused by the tilt of the optical axis X.

Similarly, in the first embodiment, by photographing the print P a plurality of times while changing the angle of the optical axis X relative to the print P little by little, inputting all the photographed-image data S2 obtained by photographing the print P a plurality of times to the first information-detecting part 37A, and computing the correlation values between all the photographed-image data S2 and the pattern W(x, y), only the photographed-image data S2 with the highest correlation value may be transmitted to the communications part 35.

Incidentally, to access the Internet or transmit and receive electronic mail with cellular telephones, cellular telephone companies provide relay servers to access web servers and mail servers. Cellular telephones are used for accessing web servers and transmitting and receiving electronic mail through relay servers. For that reason, audio data M1 to M3 may be stored in web servers, and the information attaching system of the present invention may be provided in relay servers. This will hereinafter be described as a third embodiment of the present invention.

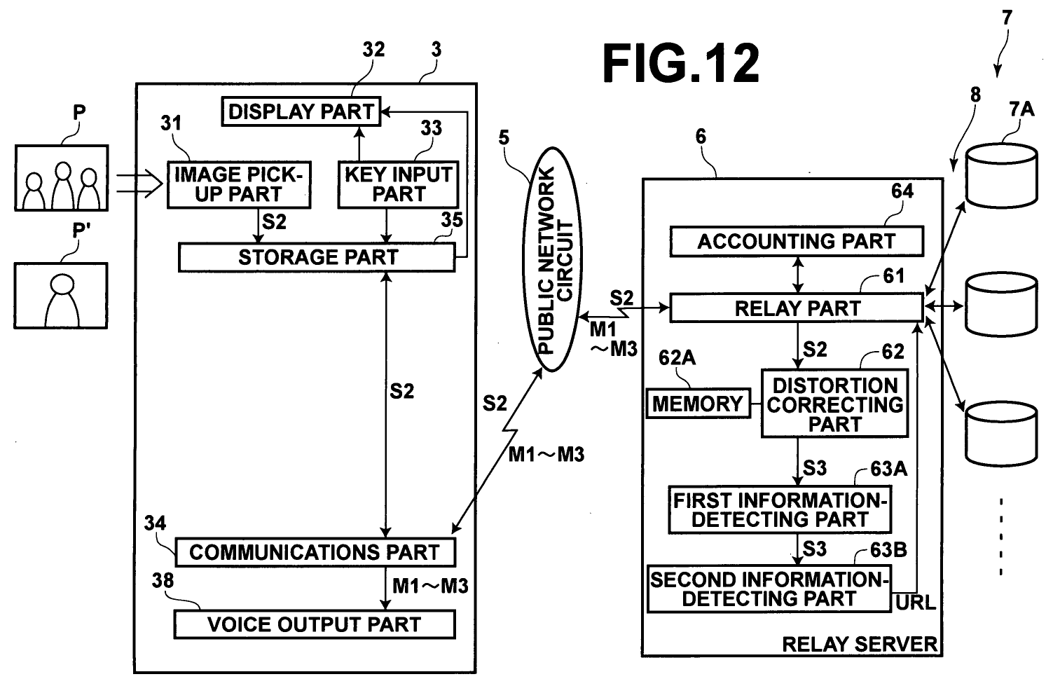

FIG. 12 shows a cellular telephone relay system that is an information transmission system with the information detecting device constructed in accordance with a third embodiment of the present invention. In the third embodiment, the same reference numerals will be applied to the same parts as the first embodiment. Therefore, a detailed description will be omitted unless particularly necessary.

As shown in FIG. 12, in the cellular telephone relay system that is the information transmission system of the third embodiment, data is transmitted and received between a cellular telephone 3 with a built-in camera (hereinafter referred to simply as a cellular telephone 3), a relay server 6, and a server group 7 consisting of a web server, a mail server, etc., through a public network circuit 5 and a network 8.

The cellular telephone 3 in the third embodiment has only the image pick-up part 31, display part 32, key input part 33, communications part 34, storage part 35, and voice output part 38, included in the cellular telephone 3 of the information transmission system 1 of the first embodiment, and does not have the first and second information-detecting parts 37A, 37B.

The relay server 6 is equipped with a relay part 61 for relaying the cellular telephone 3 and server group 7; a distortion correcting part 62 corresponding to the distortion correcting part 54 of the second embodiment; first and second information-detecting parts 63A, 63B corresponding to the first and second information-detecting parts 37A, 37B of the first embodiment; and an accounting part 64 for managing the communication charge for the cellular telephone 3. The distortion correcting part 62 is equipped with a memory 62A that stores distortion characteristic information corresponding to the type of cellular telephone 3. The memory 62A corresponds to the memory 54A of the second embodiment.

In the third embodiment, when the second information W is detected from the corrected-image data S3, the second information-detecting part 63B has the functions of detecting codes C1 to C3 from the corrected-image data S3 and of inputting URLs corresponding to the codes C1 to C3 to the relay part 61.

If URLs are input from the second information-detecting part 63B, the relay part 61 accesses a web server (for example, 7A) corresponding to the URLs, reads out audio data M1 to M3 stored in that web server, and transmits them to the cellular telephone 3.

Note that when the first information-detecting part 63A cannot detect the second information W from corrected-image data S3, a non-detection result is input from the first information-detecting part 63A to the relay part 61. The relay part 61 transmits electronic mail describing non-detection to the cellular telephone 3 so the user of the cellular telephone 3 can find that the photographed-image data S2 transmitted from the cellular telephone does not contain codes C1 to C3.

The accounting part 64 performs the management of the communication charge for the cellular telephone 3. In the third embodiment, if codes C1 to C3 are embedded in a photographed print, and the relay part 61 accesses the web server 7A to acquire audio data M1 to M3, the accounting part 64 performs accounting. On the other hand, if codes C1 to C3 are not embedded in a photographed print, accounting is not performed because the relay part 61 does not access the servers 7.

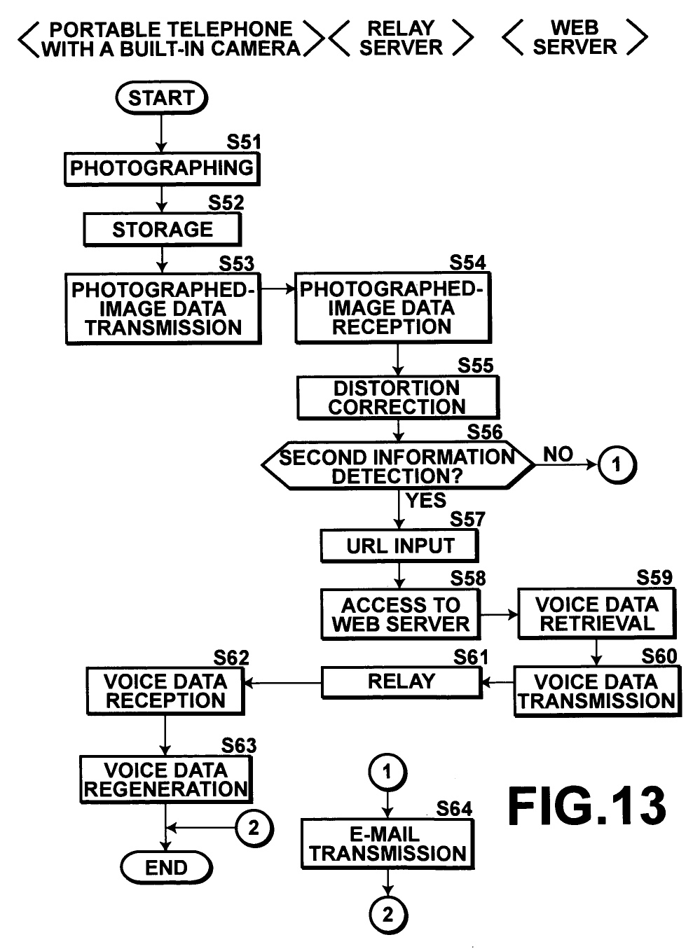

Next, a description will be given of the steps performed in the third embodiment of the present invention. FIG. 13 is a flowchart showing the steps performed in the third embodiment. A print P or P′ is delivered to the receiving user. In response to instructions from the receiving user, the image pick-up part 31 photographs the print P or P′ and acquires photographed-image data S2 representing the image of the print P or P′ (step S51). The storage part 35 stores the photographed-image data S2 temporarily (step S52). The communications part 34 reads out the photographed-image data S2 from the storage part 35 and transmits it to the relay server 6 through a public network circuit 5 (step S53).

The relay part 61 of the relay server 6 receives the photographed-image data S2 (step S54), and the distortion correcting part 62 corrects both the geometrical distortions in the photographed-image data S2 caused by the photographing lens and the geometrical distortions in the photographed-image data S2 caused by the tilt of the optical axis X and acquires corrected-image data S3 (step S55). The first information-detecting part 63A judges whether or not the second information W is detected from thecorrected-imagedataS3 (step S56).

If the judgment in step S56 is YES, the information detecting part 63 detects codes C1 to C3 from the corrected-image data S3, generates URLs from the codes C1 to C3, and inputs them to the relay part 61 (step S67). The relay part 61 accesses the web server 7A through the network 8, based on the URLs (step S58).

The web server 7A retrieves audio data M1 to M3 (step S59) and transmits them to the relay part 61 through the network 8 (step S60). The relay part 61 relays the audio data M1 to M3 and retransmits them to the cellular telephone (step S61).

The communications part 34 of the cellular telephone 3 receives the audio data M1 to M3 (step S62), the voice output part 38 regenerates the audio data M1 to M3 (step S63), and the processing program ends.

On the other hand, if the judgment in step S56 is NO, electronic mail, describing that codes C1 to C3 are not embedded in the photographed print, is transmitted from the relay part 61 to the cellular telephone 3 (step S64), and the processing program ends.

In the third embodiment, the relay server 6 is provided with the first and second information-detecting parts 63A, 63B. However, the cellular telephone 3 may include only the first information-detecting part 63A, and the relay server 6 may include only the second information-detecting part 63B. In this case, the relay server 6 does not have to perform the distortion-correcting procedure and information-detecting procedure on photographed-image data S2 in which codes C1 to C3 are not embedded. This can prevent the relay server 6 from being congested. Also, the receiving user need not transmit unnecessary photographed-image data S2, so the receiving user is able to save the cost of communications and the cost in the server 4 for detecting codes C1 to C3.

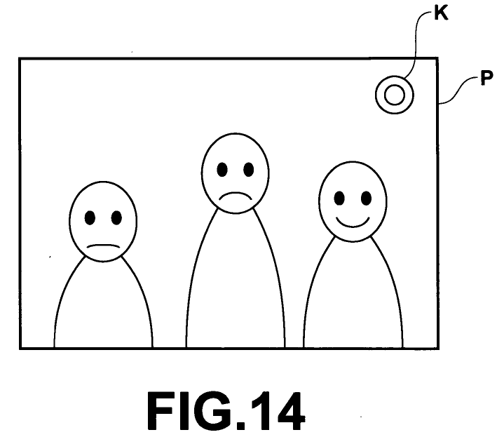

In the first through the third embodiments, although the second information W, which indicates that codes C1 to C3 are embedded in the print P, is embedded in the print P, a symbol K such as ⊚, which indicates that codes C1 to C3 are embedded in the print P, may be printed on the print P as the second information W, as shown in FIG. 14. It is preferable to print the symbol K on the perimeter of the print P which does not affect images, as shown in FIG. 14. However, it may be printed on the reverse side of the print P. Also, a text such as “This photograph is linked with voice” may be printed on the reverse side of the print P.

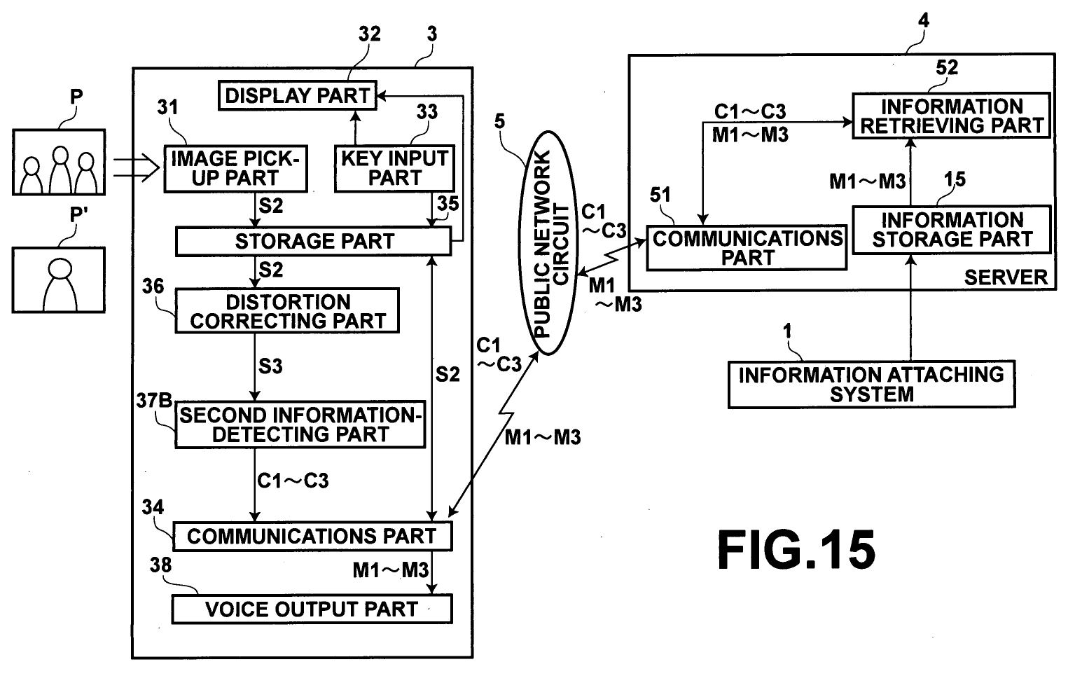

Thus, by only viewing the print P, the receiving user can judge whether or not codes C1 to C3 are embedded in the photographed print P, by the presence of the mark K. In this case, only the print P with the mark K is photographed. Therefore, as in an information transmission system of a fourth embodiment shown in FIG. 15, the first information-detecting part 37A of a cellular telephone 3 can be omitted compared with the first and second embodiments. Also, compared with the third embodiment, the first information-detecting part 63A of a relay server 6 can be omitted.

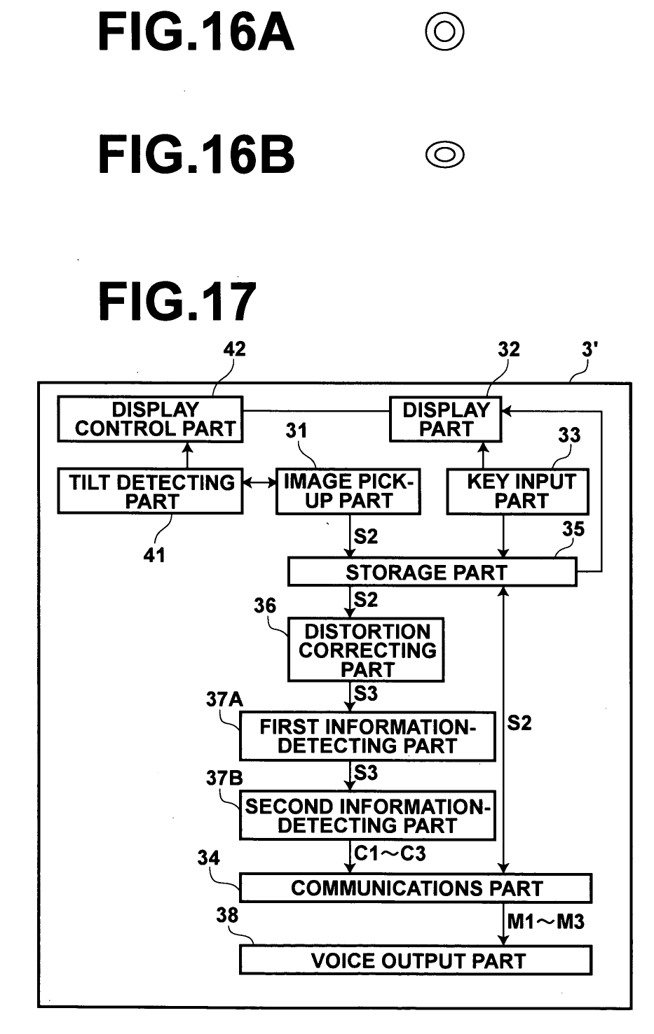

When the mark K is printed as the second information W, as shown in FIG. 14, the geometrical distortions in the photographed-image data S2 caused by the tilt of the optical axis X can be corrected by employing the mark K. For instance, consider the case where the mark K consisting of ⊚ is printed as shown in FIG. 14. When photographing is performed so the optical axis X is perpendicular to the print P, two circles are obtained as shown in FIG. 16A. However, if the optical axis X tilts, two ellipses are obtained as shown in FIG. 16B. In this case, the distortion correcting part corrects the photographed-image data S2, in which the geometrical distortions caused by the photographing lens has been corrected, so that two ellipses become two circles. In this way, the corrected-image data S3 is obtained.

The mark K is not limited to the mark ⊚. By employing a pattern with two symmetrical axes crossing at right angles, such as a circular pattern, an elliptical pattern, a star pattern, a square pattern, a rectangular pattern, etc., the geometrical distortions in the photographed-image data S2 caused by the tilt of the optical axis X can be corrected, as in the case of the mark ⊚. Instead of these patterns, even if a mesh pattern is printed as the mark K, the geometrical distortions in the photographed-image data S2 caused by the tilt of the optical axis X can be corrected, as with the case of the mark ⊚.

The mark K may correspond to a photographed object that is contained in the print P. For example, when the photographed object in the print P is an automobile, an automobile mark can be employed as the mark K. When it is a commodity, the logo of the commodity can be employed as the mark K.

In the first through the fourth embodiments, the URLs of the audio data of persons are embedded in the print P as codes. However, in a print P for the image of a commodity such as clothes, foods, etc., the URL of a web site for explaining that commodity, or the URL of audio data for explaining that commodity, may be embedded as a code. In this case, if the print P is photographed and the code is transmitted to the server 4, the receiving user can access the web site for the commodity or receive the audio data for explaining the commodity.

In the first through the fourth embodiments, the distortion correcting parts 36, 54, and 62 corrects the geometrical distortions caused by the tilt of the optical axis X. However, as shown in FIG. 17, a cellular telephone 3′ may be provided with a tilt detecting part 41 that detects the tilt of the optical axis of an image pick-up part 31 relative to a print P, and a display control part 42 that displays information representing the tilt of the optical axis detected by the tilt detecting part 41 on a display part 32.

The tilt detecting part 41 detects the angle of the optical axis by computing a difference between the angle of the two sides of the print P crossing at right angles, contained in the image represented by photographed-image data S2, and 90 degrees. In the case where the second information W is attached to the print P by the mark K, the tilt detecting part 41 detects the angle of the optical axis by a method of computing the amount of the mark K in the image represented by the photographed-image data S2, distorted from the original mark K.

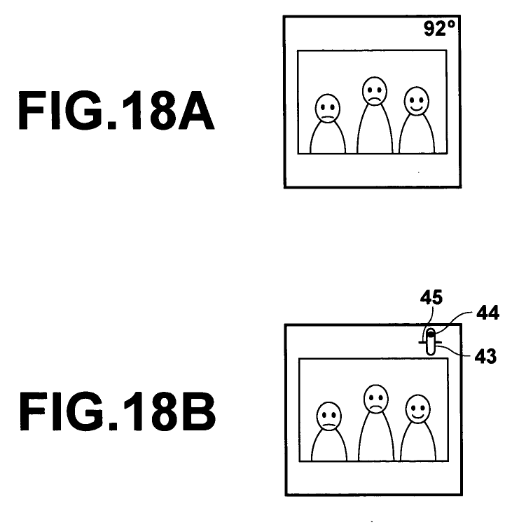

The display control part 42 displays on the display part 32 the information representing the tilt of the optical axis, detected by the tilt detecting part 41. More specifically, as shown in FIG. 18A, the angle is displayed in a numerical value, or as shown in FIG. 18B, a level 43 is displayed. In the level 43, a black dot 43 moves according to the angle of the image pick-up part 31 relative to the optical axis. When the black dot 44 is at a reference line 45, it indicates that the optical axis is perpendicular to the print P.

In the first through the fourth embodiments, while the URLs of the audio data M1 to M3 are embedded as digital watermarks, the telephone numbers for persons contained in the print P may be embedded. In this case, the persons in the print P can secretly transmit their telephone numbers to the user of the cellular telephone 3 without it becoming known to others. On the other hand, the user of the cellular telephone 3 is able to obtain the telephone numbers of the persons in the print P from the photographed-image data S2 obtained by photographing the print P with the cellular telephone 3, whereby the user of the cellular telephone 3 is able to call the persons contained in the print P.

In the first through the fourth embodiments, the codes C1 to C3 are detected from the corrected-image data S3 obtained by correcting the photographed-image data S2, but there are cases where the photographing lens of the image pick-up part 31 is high in performance and contains no geometrical distortions or contains little geometrical distortions. In such cases, the codes C1 to C3 can be detected from photographed-image data S2 without correcting the geometrical distortions in the photographed-image data S2 caused by the photographing lens. Also, by photographing the print P so the optical axis becomes perpendicular to the print P, the codes C1 to C3 can be detected from photographed-image data S2 without correcting the geometrical distortions in the photographed-image data S2 caused by the tilt of the optical axis.

In the first through the fourth embodiments, the print P is photographed with the cellular telephone 3 and the audio data M1 to M3 are transmitted to the cellular telephone 3. However, the audio data M1 to M3 may be transmitted to personal computers and reproduced, by reading out an image from the print P with a camera, scanner, etc., connected to personal computers, and obtaining the photographed-image data S2.

In the first through the fourth embodiments, the audio data M1 to M3 are transmitted to the cellular telephone 3. However, the audio data M1 to M3 may be regenerated in the cellular telephone 3 by making a telephone call to the cellular telephone 3 instead of transmitting the audio data M1 to M3.

While the present invention has been described with reference to the preferred embodiments thereof, the invention is not to be limited to the details given herein, but may be modified within the scope of the invention hereinafter claimed.

What is claimed is:

1. A print generating device for hiddenly embedding first information in an image to acquire an information-attached image and generating a print on which said information-attached image is recorded, comprising:
embedding means for hiddenly embedding the first information in the image; and
information attaching means for attaching second information, which indicates that said first information is embedded in said image, to said print.

2. The print generating device as set forth in claim 1, wherein said information attaching means is means to attach said second information to said print by hiddenly embedding said second information in said image in a different embedding manner than the manner in which said first information is embedded.

3. The print generating device as set forth in claim 1, wherein said information attaching means is means to attach said second information to said print by a visual mark.

4. An information detecting device comprising:
input means for receiving photographed-image data obtained by photographing an arbitrary print, which includes said print generated by said print generating device as set forth in claim 2, with image pick-up means;
judgment means for judging whether or not second information, which indicates that first information is embedded in an image, is detected from said photographed-image data; and
processing means for performing a process for detection of said first information on only the photographed-image data from which said second information is detected.

5. The information detecting device as set forth in claim 4, further comprising distortion correction means for correcting geometrical distortions contained in said photographed-image data when said processing means is means to perform detection of said first information as a process for detection of said first information;
wherein said judgment means and said processing means are means to perform said judgment and said detection on the photographed-image data corrected by said distortion correction means.

6. The information detecting device as set forth in claim 5, wherein said distortion correction means is a means for correcting geometrical distortions caused by a photographing lens provided in said image pick-up means and/or geometrical distortions caused by a tilt of an optical axis of said photographing lens relative to said print.

7. The information detecting device as set forth in claim 4, wherein said processing means is a means for performing a process of transmitting said photographed-image data to a device that detects said first information, as a process for detection of said first information, and is a means for transmitting said photographed-image data to said device that detects said first information, only when said judgment means detects said second information from said photographed-image data.

8. An information detecting device comprising:
input means for receiving photographed-image data obtained by photographing an arbitrary print, which includes said print generated by said print generating device as set forth in claim 3, with image pick-up means; and
processing means for performing a process for detection of said first information.

9. The information detecting device as set forth in claim 8, further comprising distortion correction means for correcting geometrical distortions contained in said photographed-image data when said processing means is a means for performing detection of said first information as a process for detection of said first information;
wherein said processing means is a means for performing said process for detection on the photographed-image data corrected by said distortion correction means.

10. The information detecting device as set forth in claim 9, wherein said distortion correction means is a means for correcting geometrical distortions caused by a photographing lens provided in said image pick-up means and/or geometrical distortions caused by a tilt of an optical axis of said photographing lens relative to said print.

11. The information detecting device as set forth in claim 4, wherein said image pick-up means is a camera provided in a portable terminal.

12. The information detecting device as set forth in claim 4, wherein said image pick-up means is equipped with display means for displaying said print to be photographed, tilt detection means for detecting a tilt of an optical axis of said image pick-up means relative to said print, and display control means for displaying information representing the tilt of said optical axis detected by said tilt detection means, on said display means.

13. The information detecting device as set forth in claim 4, wherein said first information is location information representing a storage location of audio data correlated with said image, and which further comprises audio data acquisition means for acquiring said audio data, based on said location information.

14. A print generating method comprising the steps of:
embedding first information in an image hiddenly and acquiring an information-attached image;
generating a print on which said information-attached image is recorded; and
attaching second information, which indicates that said first information is embedded in said image, to said print.

15. The print generating method as set forth in claim 14, wherein said second information is attached to said print by hiddenly embedding said second information in said image in a different embedding manner from the manner in which said first information is embedded.

16. An information detecting method comprising the steps of:
receiving photographed-image data obtained by photographing an arbitrary print, which includes said print generated by the method as set forth in claim 15, with image pick-up means;
judging whether or not second information, which indicates that first information is embedded in an image, is detected from said photographed-image data; and
performing a process for detection of said first information on only the photographed-image data from which said second information is detected.

17. A program for causing a computer to execute:
a procedure of embedding first information in an image hiddenly and acquiring an information-attached image;
a procedure of generating a print on which said information-attached image is recorded; and
a procedure of attaching second information, which indicates that said first information is embedded in said image, to said print.

18. The program as set forth in claim 17, wherein said procedure of attaching said second information to said print is a procedure of attaching said second information to said print by hiddenly embedding said second information in said image in a different embedding manner from the manner in which said first information is embedded.

19. A program for causing a computer to execute:
a procedure of receiving photographed-image data obtained by photographing an arbitrary print, which includes said print generated by the program as set forth in claim 18, with image pick-up means;
a procedure of judging whether or not second information, which indicates that first information is embedded in an image, is detected from said photographed-image data; and
a procedure of performing a process for detection of said first information on only the photographed-image data from which said second information is detected.
